(19) United States
(12) Patent Application Publication
(10) Pub. No.: US 2003/0168147 A1
(43) Pub. Date: Sep. 11, 2003

(54) Metod for identifying apparel items and other goods

(75) Inventor: Frederick August Bleckmann, Barrington, NH (US)

Correspondence Address: NIXON PEABODY, LLP, 8180 GREENSBORO DRIVE, SUITE 800, MCLEAN, VA, 22102, US

(73) Assignee: Pittsfield Weaving Co., Inc., Pittsfield, NH (US)

(21) Appl. No.: 10/329,778

(22) Filed: Dec. 27, 2002

Related U.S. Application Data
(60) Provisional application No. 60/343,644, filed on Dec. 28, 2001.

(51) Int. Cl. G08B 13/14

(52) U.S. Cl. 156/64; 340/572.8

(57) ABSTRACT

The present invention relates to a method of identifying apparel items and goods, the method comprising the steps of providing at least one radio frequency device, inscripting an identifying factor of the at least one radio frequency device, designating an operating frequency range for the identifying factor, and joining the radio frequency device to a carrier. The carrier can than be attached to an apparel item or other type of goods. The method of the present invention further comprises the step of designating an option into each identifying factor and designating an operating frequency range for the option, the option frequency range being within the operating frequency range of the factor. The step of inscripting an identifying factor in the at least one radio frequency device comprises inscripting a factor identifying for example, authenticity, date or location of manufacture, size, color, style, or other identifying information.

### RELATED APPLICATIONS

This application claims priority of U.S. Provisional Application Serial No. 60/343,644filed on Dec. 28, 2001.

This application is also related to co-pending U.S. patent application Ser. Nos. 09/603,234 entitled “Method and Apparatus for Production of Labels” and 10/143,842 entitled “Method and Apparatus for Production of RF Labels.”

### BACKGROUND OF THE INVENTION

1. Field of the Invention

The present invention relates to a method for the production of labels incorporating multiple radio frequency (RF) devices attached to an apparel item for the purpose of identifying large combinations of varying product, and more particularly to a label incorporating the identifying RF devices.

The attachment of labels to cloth goods such as clothing, linens and towels is a common practice used to set forth information such as trademarks and trade names, material identification and characteristics, sizes, care instructions, and so forth. In addition, legal requirements necessitate the use of labels in clothing or on linens. A method and apparatus for producing individual folded labels from a ribbon of labels is presented in published PCT application WO 00/50239 and is incorporated in its entirety herein.

Folded labels are commonly used in the industry and come in a number of different forms including endfolds, centerfolds, J folds, Booklet fold, Manhattan-folds, and mitrefold labels. While each of these different forms has a particular use, the centerfold and end-fold labels are the most popular.

Currently most folded labels are produced using what is referred to in the industry as the “cut and fold” technique, that is the labels are indexed, cut from a ribbon of material and then folded. Using this technique about 40-220 labels can be produced a minute with between 5-20% of the labels being considered waste or defective. The most common defect being a distorted fold resulting in the ends of the label not aligning properly. Other defects include turned corners, fanning, and protruding fold-unders.

As fully disclosed in U.S. patent application Ser. No. 10/143,842, commonly owned by the assignee of the present invention, a ribbon of labels with RF devices encapsulated therein can be subdivided into individual RF labels using ultrasonic means resulting in individual folded RF labels that are both soft to the touch, i.e., having edges that are generally scratchless to the apparel consumer, and capable of storing and transmitting identifying information and at the same time virtually free of defects.

It would be desirable to be able to produce folded labels incorporated with RF devices for storing and transmitting identifying information and that are more comfortable to the apparel customer than current labels. In addition, it is desirable to produce such labels at a higher speed and at a greater efficiency of production for both label and end product manufacturers, and with fewer defects than current methods.

Apparel items and other goods have certain identifying specifications that can be broken down into different factors and these factors contain certain options. Therefore, for example, apparel items are sorted at distribution centers by several factors, i.e., style, color, size, authenticity, date of manufacture, shipping instructions, contractor, etc. These factors can contain several options. A defining factor such as product color would contain several options, such as red, blue, and/or green. A defining factor such as size would contain several options, such as small, medium, large.

However, the apparel items arrive at a distribution center or warehouse facility unsorted. The items need to be sorted and distributed to their desired location within the distribution facility. It is also desirable for a facility to receive apparel goods from outside contractors with this information already traveling with the item.

Problems present during the sorting process which are obstructive, i.e., increased labor and costs. Moreover, since there are large number of possible combinations which must be stored on a bar code, a single device or referenced using unique numbers per item.

It would be useful at the point of sale or before to know and identify the date of manufacture, authenticity or season code of a given item.

It would be desirable to be able to account for the necessary identifying factors in a simplified, inexpensive manner to provide a record on the item as to its specification.

### SUMMARY OF THE INVENTION

It is an object of the method of the present invention to allow for the attachment of identifying information to apparel items or goods at the point of manufacture, during normal operating procedures without the need for expensive scanning equipment to write information to a device. This method also removes the need for using a large number of unique identifiers for all the combinations of different options across a number of factors, i.e., size, color, style, date of manufacture, authenticity, etc.

Another object of the present invention is to provide a method and label wherein each identifying factor is designated to operate within a specified frequency range. For example, for the factor of color, the frequency range can be designated of between 12 Mhz to 18 Mhz, for the size factor, the frequency range can be designated of between 19 Mhz to 24 Mhz, and for the factor of style of between 25 Mhz to 35 Mhz. A greater number of factors are possible. Any factor or option can be within any range of radio frequency reflection, for example, of between 1 kHz and 6.0 Ghz.

It is another object of the present invention to provide a method and label wherein within each identifying factor there are multiple options. For example, each option within a specific identifying factor could be designated by a device operating at a smaller frequency range. Thus, within the identifying factor of color, having a range of between 12 Mhz to 18 Mhz, as exemplified above, specific color options for red, blue, green, or any other color could be designated. Thus, for the option of red, a frequency range of 12.1 Mhz to 13.4 Mhz, for the option of blue, a frequency range of between 13.5 Mhz to 15.1 Mhz, and for the option of green a frequency range of between 15.2 Mhz to 17.9 Mhz.

With regard to the identifying factor of date, a range of 122 Mhz to 154 Mhz is possible. Thus, for the option of a month (February) , a frequency range of 122 Mhz to 122.2 Mhz, for the option of day (25^{th}), a frequency range of 144.1 Mhz to 146.4 Mhz, and for the option of year (1999) a frequency range of 152.1 Mhz to 152.8 Mhz.

In another embodiment, such information could also be carried by a device which operates at a single frequency and designated the factors, and the options within those factors, using closed and open circuits or bits. Each device carrying information about a particular option which is within a particular factor.

In accomplishing these and other objects of the present invention, there is provided a method of identifying apparel items and goods, the method comprising the steps of providing at least one radio frequency device, inscripting an identifying factor in the at least one radio frequency device, designating an operating frequency range for the identifying factor, and joining the radio frequency device to a carrier. The carrier can than be attached to an apparel item or other type of goods.

The method of the present invention further comprises the step of inscripting an option into each identifying factor and designating an operating frequency range for the option, the option frequency range being with the operating frequency range of the factor. The step of inscripting an identifying factor in the at least one radio frequency device comprises inscripting a factor identifying size, color or style. The operating frequency range for the identifying factor of color being of about 12 Mhz to 18 Mhz, the operating frequency range for the identifying factor of size being of about 19 Mhz to 24 Mhz, and the operating frequency range for the size identifying factor being of about 25 Mhz to 35 Mhz.

These and other objects, features, aspects, and advantages of the present invention will become more apparent from the following detailed description of the preferred embodiment relative to the accompanied drawings, in which:

### BRIEF DESCRIPTION OF THE DRAWINGS

FIG. 1 is a perspective view of an apparatus for producing a folded label having a RF device incorporated therein.

FIG. 2 illustrates a label having an RF device incorporated therein.

FIG. 3 is a perspective view of an apparel item with labels incorporating the identifying factors.

FIGS. 4A-4C illustrate an inventory of identifying options available grouped by factor.

### DETAILED DESCRIPTION OF PREFERRED EMBODIMENTS

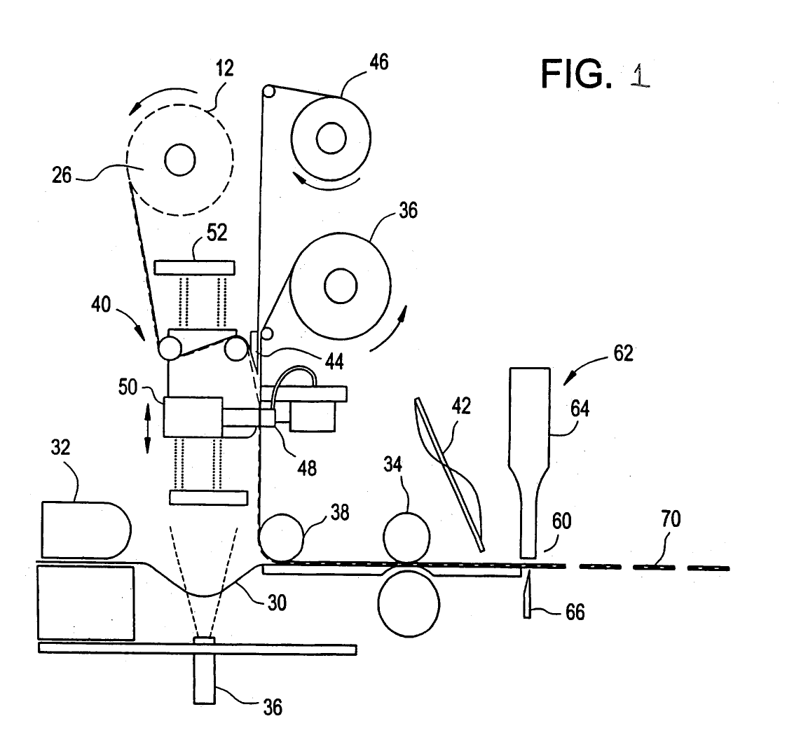

Referring to FIG. 1, an apparatus for attaching RF devices to a woven label is shown. Carrier strip 12 having RF devices adhered thereto is mounted on a roller 26. Folded ribbon 30 of material containing labels is advanced from a press station 32 via a drive roller 34. The apparatus has two linear drive mechanisms. The first, which is part of the press station, is an uninterrupted linear advance, which maintains tension during folding. The second is an indexing mechanism. Regulating the tension of the ribbon of material is important during the folding process. In particular, the upper edge and the lower edge of the material must be maintained at essentially equal tensions. A centerline of the material is the main control for this adjustment. The centerline is preferably setup equal to the centerline of the press unit and the folding station. Raising or lowering the roll from this point can be done to equalize the tensions in the upper and lower edge of the material.

Folded ribbon of labels 30 can be composed of virtually any material that can be cut and pressed including a thermoplastic material (e.g., polyester), acetate, cotton, nylon, linen, paper, rayon and combinations thereof, in woven and non-woven form. Polyester is preferred. The labels can be printed or woven, however, woven is preferred. A woven label is one of a fabric having a weft and warp.

In the folding station (not shown) folded label ribbon 30 can be guided through a series of adjustable equalizing rollers (not shown) that make up the tension equalizer assembly to provide an even distribution of tension. After emerging from the equalizing rollers, the ribbon is guided over a folding rod (not shown).

For producing a centerfold label, the folding station comprises two folding lenses (not shown). Folding lenses are pivotably mounted on supports and can be adjusted vertically. The lenses are a caliper-like device comprising two adjustable jaws. The lenses restrain and guide the material into an even consistent fold. One lens can be a guiding lens used for making for slight adjustments before the material enters the other lens, the working lens that brings the ribbon to a fold. In certain situations a proper fold can be obtained using more or less that two lenses.

The folded material exits the folding station and enters the press station. The press station subjects the folded material to both heat (100°-400° F.) and pressure. A range of pressure between 5-80 pounds of force is preferred. In one embodiment, the press unit includes a support frame upon which are movably affixed belt rolls about which is positioned a high temperature resistant endless conveyor belt. The belt may be driven at selected, controlled, constant speeds by known means such as an AC or DC electric drive motor and speed regulator or controller. Between the affixed belt rolls are a series of rollers, spring mounted to the support frame, upon which the top of the conveyor rides.

The speed of the press station motor can be trimmed with an ultrasonic range-finder that is wired into the motor controller inside the unit. A speed signal is sent to the servo-motor. From this signal a calculation is made and held in memory. The ultra sonic range finder makes a reading of the slack of material as it travels between press station and cutting station. This is added to the number held in memory and this sum is sent to the belt drive motor to control belt speed. Alternatively, the indexing speed of the motor can be trimmed to the conveyor.

The press station can have multiple heat zones that can be controlled separately. The first heat zone can be designed to carry most of the heat and the heat zones can be designed as a cool down area. The settings of the press station are dictated by the type of material being processed. Thicker materials require a higher press setting and more heat, while thinner materials require less.

The folded material travels though the press unit via a conveyer mechanism. It is this conveyor mechanism that provides a linear advance pulling the ribbon from the tension let off device through the folding station. Other mechanisms for advance can be used.

The folded pressed ribbon exits the press station and is led to the cutting station on a support plate. Upon advance of the material, downward pressure from the roll is dependent on material thickness, and structure. Thinner, looser structure materials require low pressure. Thicker and more stable structures of material require a higher downward pressure.

A sensor 36 is used to monitor and control the slack of the folded ribbon of labels 30 between an applicator unit 40, which will be described further herein, and drive roller 34 through a control unit (not shown). The speed of the applicator 40 is controlled to stay consistent with the advancing material and the delays set for cut time and acceleration and deceleration of the servo motor that turns drive roller 34.

A roll of ribbon of material 36 is also advanced via drive roller 34. Drive roller 34 pulls folded ribbon of labels 30 and fabric ribbon of material 36 forward and under a fiber optic eye 42. To maintain the proper alignment for materials with logos and written instructions such as woven or printed labels, the fiber optic eye is used, which reads color contrast as material advances past its read point. When a registration point passes under the eye or when the eye sees a color change an immediate interrupt signal is sent to the controller, at this point the servo motor, via roller 34, advances the material the distance set in the operator interface. The deceleration is calculated so that the material advance will be accurate to +−0.05 mm. At this point the material remains stopped for the cutting, e.g., knife delay time set on the operator interface. The material then advances and follows the same sequence above.

A typical setting for the advance is the width of the label (length along loom cut edge) minus 5 mm. This number may be adjusted to influence centering of the logo. Additional adjustment can be made if necessary.

At the stop, carrier strip 12 is advanced over a peeler 44 presenting the RF devices 20 to ribbon of material 36. The carrier strip minus devices 20 is rewound unto roller 46. Alternatively, the carrier strip 12 can be eliminated and substituted with the ribbon of material 36, negating the need to peel and rewind a carrier strip.

Applicator 40 includes an anvil and attached piston 48. Anvil 48 includes a vacuum device which attracts ribbon of material 36. The piston activates an ultrasonic horn 50 which welds the RF device to ribbon of material 36. The applicator unit is adjustable via a frame 52 to align with the logo on folded ribbon of labels 30.

The ribbon of material 36 with the RF devices 20 mounted thereon is guided by roller 38 and drive roller 34 to cutting station 60. The RF device is registered with the logo on the label ribbon by advance of both ribbons 30, 36 through drive roller 34 and optic eye 42.

The material is cut at cutting station 60 to form folded labels 70 using an ultrasonic system 62 comprising a horn 64 and an anvil 66. For example, the ultrasonic horn 64 has sound waves moving through it at a frequency of 20-40 KHz. The residence of these waves can be magnified through proper booster and horn combination.

Anvil 66 is actuated at an adjustable pressure to collide with the horn. The material passes between the horn and the anvil and is exposed to very high-localized heat, cutting and sealing the material. The larger the radius on the anvil the larger the seal area and the more pressure required for a cut. The default delay time for the knife up is calculated and taken into account. For example, a typical delay is 70 ms, which may be adjusted if necessary to accomplish the desired results. Ultrasonic rotary dies can also be used.

The cutting station can utilize other known cutting techniques to subdivide the ribbon into individual labels. Such techniques include, for example, cold or hot shearing knives, hot fuse knives that squeeze off the product during cutting, extreme high mechanical pressure, high-pressure air, high-pressure water, laser cutting, rotary die cutters, and others. In the case of the fabric carrier, the fabric carrier is cut and bonded to the cut edges of the label. The fabric layer can be within a centerfold label, along the back of a centerfold label, along the front of a centerfold label along the back of an end fold label, along the front of an end fold label, along the front of an end fold label, or any of the above conditions on other labels processed on the equipment.

Unlike centerfold labels produced using traditional techniques, the centerfold label has the front and back folds sealed together along an edge with the RF device therein. By using alternative folding stations, the apparatus of the present invention can be used to form other varieties of folded labels. For example, to form “end-fold” labels.

The apparatus of FIG. 1 is particularly suited for insertion of RF devices such as security, authenticity and inventory control devices, e.g., radio frequency inventory devices (RFID) tags, into labels. RFIDs are known in the art and include that disclosed in U.S. Pat. Nos. 5,874,902; 5,874,896; 5,785,181; and 5,745,036. Such devices can be inserted at a number of locations. By using an ultrasonic cutting system, these devices can be sealed into the bonded top and bottom edges of the material. This will cause the label to be destroyed if the device is removed; thus guaranteeing the tag and label stay as one during processing. At one location, the folded material is opened and the device is inserted at desired positions. At another location, adhesive backed devices are placed on the material before folding. Edge sealing can be achieved with these methods as well.

The RF tag can have it's frequency range manufactured therein. In order to change this frequency after manufacture, a part or bit thereof can be shorted out to reflect a lower frequency

The RF tag can be chip based wherein the RFID tag can include a scannable circuit board chip. The RFID technology will allow a RF label to be read or written to. The ability to write to the RF labels enables users to keep and update a database without the end user being able to alter the information on the embedded circuit board. In addition, the identification information may be reused and written over.

Look-up databases can be readily available to facilitate quick access to the information embedded on the RF labels. Moreover, lost or stolen items having the RF labels can be reunited with its owner or place of origin. The scannable RF labels enable tracking of inventory, pricing and place of origin, without necessitating human intervention to research such information. The programmable and read-only scannable circuit boards cannot be altered or read without a programmer or reader.

Commercially available RF devices operate in a wide range of high and low frequencies, for example, 13.56 Mhz, 915 Mhz, 2.45 Ghz and 5.6 Ghz. Low frequency tags usually employ a multi-turn coil resulting in a tag having a thickness much greater than a standard sheet of paper. 2.45 Ghz and 5.6 Ghz can be done in a single turn or as a die pole antenna. High frequency passive tags, which operate at around 2.54 Ghz, typically consist of a single turn, flat antenna, printed onto a flat single layer sheet of plastic or paper.

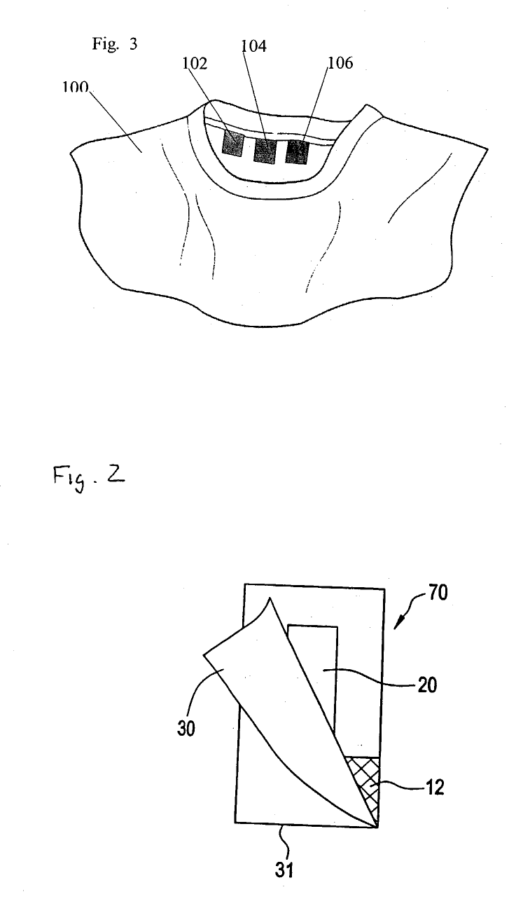

A label incorporating an RF device is illustrated in FIG. 2. As shown, label 70 includes an RF device 20 disposed in the folded ribbon of materials 30. As previously discussed herein, the device 20 can be delivered via a carrier strip 12.

The method of the present invention allows for the attachment of identifying information at the point of manufacture during normal operating procedures. Apparel items and other goods can be defined and identified by numerous factors, such as size, style and color, authenticity and date of manufacture. Although, the method of the present invention is described in relation to the factors of size, color and style, it should be understood that other factors can be identified, and the instant invention is not intended to be limited to these three factors.

Referring to FIG. 3, an apparel item 100 having a plurality of labels or carriers 102, 104, 106 containing a device, such as an RF device (not shown), each identifying a different factor, size, style and color is shown.

At the point of manufacture, each factor is designated to operate within a predetermined frequency range. For example, the identifying factor of color can range of and about 12 Mhz to 18 Mhz. The identifying factor of size can range of an about 19 Mhz to 24 Mhz. The identifying factor relating to style can range of and about 25 Mhz to 35 Mhz.

Each factor can have multiple options. For example, if there where more than one option in a factor, each option within that factor is designated to operate within a smaller frequency range than that designated for the entire factor. For example, within the frequency range of the color factor (12 Mhz to 18 Mhz) the red option could be designated of about 12.1 Mhz-13.4 Mhz; the blue option of about 13.5 Mhz to 15.1 Mhz; and the green option of about 15.2 Mhz to 17.9 Mhz.

It should be appreciated that such above information could also be carried by a device which operates at a single frequency, whereby the factors and the options within those factors can be designated using closed and open circuits and bits, amplitude or other distinguishing characteristics.

Thus, referring again to FIG. 3, the apparel item 100 when assembled includes a carrier or label 102 incorporating a device which reflects the corresponding data, such as, size factor small, carrier or label 104 incorporating a device which reflects data, such as the color red, and carrier or label 106 incorporating a device reflecting a style, such as oxford.

The combination of these three separate devices, would than build a record on the item as to it's overall specification. This specification would travel with the item. As previously set forth, additional labels incorporating devices reflecting data of additional options can also been sewn within the garment or attached to goods. Although, only one option per factor of the specification will be attached to the apparel item.

Although described with relation to labels or carriers incorporating the RF devices sewn into apparel or goods, the device could also be attached with a sticker onto hard goods.

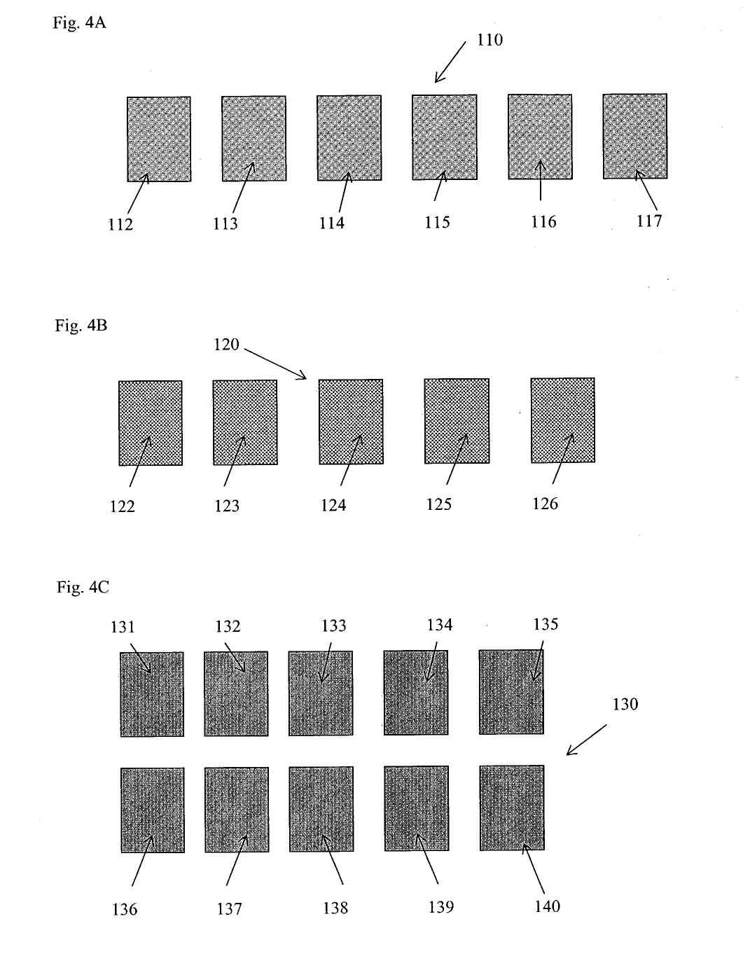

Referring to FIGS. 4A-4C, an inventory of options of different devices is grouped by factor. As shown in FIG. 4A, devices 110 incorporating a first factor of color are shown. The factor of color could have six different options 112-117. The specific color options can be pre-designated by the manufacturer.

As shown in FIG. 4B, devices 120 incorporating the factors of size having five different options 122-126. For example, Petit, small, medium, large, X-large.

As shown in FIG. 4C, devices 130 incorporating the factors of style are shown. The factor of style can have ten different options 131-140. The specific options can also be predetermined by the manufacturer.

Importantly, other options could consist of the location or manufacturing site, the year of manufacture, special shipping instructions, etc. It should be appreciated that the present invention is not limited to any specific factor or option, as the present invention contemplates other factors and options not specifically mentioned herein.

As can be appreciated from FIGS. 4A-4C, using a different number to represent each combination of options within each factor results in a very large number of different identifiers. If one device or identifier per item were used for six colors, five sizes, and ten styles the total of combinations would require 900 different identifiers.

However, using the method of the present invention, only 21 different identifiers are needed. Moreover, single devices that can provide a large number of identifiers are more expensive than single identifying devices. Thus, the method of the present invention would also allow larger production runs of devices that are of fewer combinations.

The combination of the folded labels with a RF device in the present invention allows for identifying different factors and options for each factor, locating and tracking of items, detecting items and reporting of pricing, for example. This ability to read RF labels from codes may be utilized, for example, as the items having the RF labels leave or enter predetermined areas or locations.

Although the present invention has been described in relation to particular embodiments thereof, many other variations and modifications and other uses will become apparent to those skilled in the art. It is preferred therefore, that the present invention be limited not by the specific disclosure herein, but only by the appended claims.

What is claimed is:

1. A method for identifying apparel items and goods, the method comprising the steps of:
providing at least one radio frequency device;
inscripting an identifying factor in the at least one radio frequency device;
designating an operating frequency range for the identifying factor; and
joining the radio frequency device to a carrier.

2. The method of claim 1, further comprising the step of attaching the carrier to an apparel item or good.

3. The method of claim 1, further comprising the step of inscripting an option within each identifying factor.

4. The method of claim 3, further comprising the step of designating an operating frequency range for the option, the option frequency range being within the operating frequency range of the factor.

5. The method of claim 4, wherein the step of inscripting an identifying factor in the at least one radio frequency device comprises inscripting a factor identifying size, color or style.

6. The method of claim 1, wherein a plurality of radio frequency devices are provided, each radio frequency device being embedded with an identifying factor.

7. A carrier produced according to claim 1.

8. A carrier produced according to claim 4.

9. The method of claim 1, wherein the step of inscripting an identifying factor in the at least one radio frequency device comprises inscripting an identifying factor designating the date of manufacture.

10. The method of claim 3, wherein the step of inscripting an option within each identifying factor comprises inscripting a range of identifying options, the identifying options being the month, day, and year.

11. The method of claim 1, wherein the step of inscripting an identifying factor in the at least one radio frequency device comprises inscripting an identifying factor designating authenticity of a particular brand item.

12. The method of claim 3, wherein the step of inscripting an option within each identifying factor comprises inscripting an identifying option designating a season code.

13. The method of claim 3, wherein the step of inscripting an option within each identifying factor comprises inscripting an identifying option designating a location code.
